(19) United States
(12) Patent Application Publication
(10) Pub. No.: US 2009/0147524 A1
(43) Pub. Date: Jun. 11, 2009

(54) POINT LIGHT SOURCE WITH ACCURATE POSITIONING

(75) Inventor: Roger WILLIAMS, Acton, MA (US)

Correspondence Address: WILMERHALE/BOSTON, 60 STATE STREET, BOSTON, MA, 02109, US

(73) Assignee: Xenon Corporation, Wilmington, MA (US)

(21) Appl. No.: 12/330,129

(22) Filed: Dec. 8, 2008

Related U.S. Application Data
(60) Provisional application No. 60/992,925, filed on Dec. 6, 2007.

(51) Int. Cl. F21V 7/08; F21V 7/00; H01J 5/50

(52) U.S. Cl. 362/296.06; 362/296.01; 313/318.12

(57) ABSTRACT

A lamp system that has two opposed electrodes for forming an arc with end cap connection has an electrode and a connector made from a unitary conductor as opposed to two parts that need to be connected and positioned after connection. The lamp assembly is particularly useful in cases in which accurate positioning of the arc is useful or even critical such as an application's used to provide light for an optical fiber or other small target.

### CROSS-REFERENCE TO RELATED APPLICATIONS

This application claims priority to provisional application Ser. No. 60/992,925, filed Dec. 6, 2007, which is incorporated herein by reference.

### BACKGROUND

FIG. 1 shows a prior art pulsed xenon lamp designed to emit visible light. An envelope for this particular lamp is selected to pass visible light and block UV light. This lamp is used with a reflector to provided high intensity pulsed visible light over a small diameter, e.g., less than 0.5 inches (1.25 cm) and potentially as small as the width of an optical fiber. The reflector can be ellipsoidal, and positioned such that the lamp is at one of the foci, and the target is at the other of the foci. Such a lamp with visible light from a point source has been used for medical applications to observe vibrations.

The lamp has two opposed electrode assemblies 10, 12 that are energized to form an arc. The principles of operation of such a lamp for pulsed light are generally known. Each electrode assembly is coupled to an electrical connector 14. The connection between the electrode assembly and a lamp envelope 15 can be made with a metal seal, referred to as an end cap approach (as shown in FIG. 1), or with a graded seal that uses a series of types of glasses to make a transition from the coefficient of expansion of the envelope to the metal.

The electrode has a tungsten tip portion 16, a copper shaft 18, and a metal-to-glass seal 20. The copper shaft extends through the seal 20. The electrical connector has a cylindrical bore for receiving the shaft 18 and is bonded, e.g., with solder. The electrode assembly and the electrical connector are thus provided as two distinct items that are bonded together at final assembly of the lamp.

### SUMMARY

A lamp system that has two opposed electrodes for forming an arc with end cap connection has an electrode and a connector made from a unitary conductor as opposed to two parts that need to be connected and positioned after connection. The connector includes a mechanical connection for mating with a holder/socket. The connection can be made with a keyway, shoulders, or tabs, or some other interconnection that provides an accurate position in three coordinate axes. The lamp assembly described here is particularly useful in cases in which accurate positioning of the arc is useful or even critical such as an application's used to provide light for an optical fiber or other small target, or for solar testing.

Other features and advantages will become apparent from the following detailed description, drawings, and claims.

### BRIEF DESCRIPTION OF THE DRAWINGS

FIG. 1 is a side view of a two-art lamp assembly that shows an electrode assembly and an electrode connector that are connected together.

FIG. 2 is a single part assembly that has a combined electrode and end connector formed as a unitary and monolithic piece.

FIG. 3 is a schematic of the lamp assembly of FIG. 2 for use with an optical fiber.

FIG. 4 is a cutaway view of a solar cell tester using the lamp assembly of FIG. 2.

### DESCRIPTION

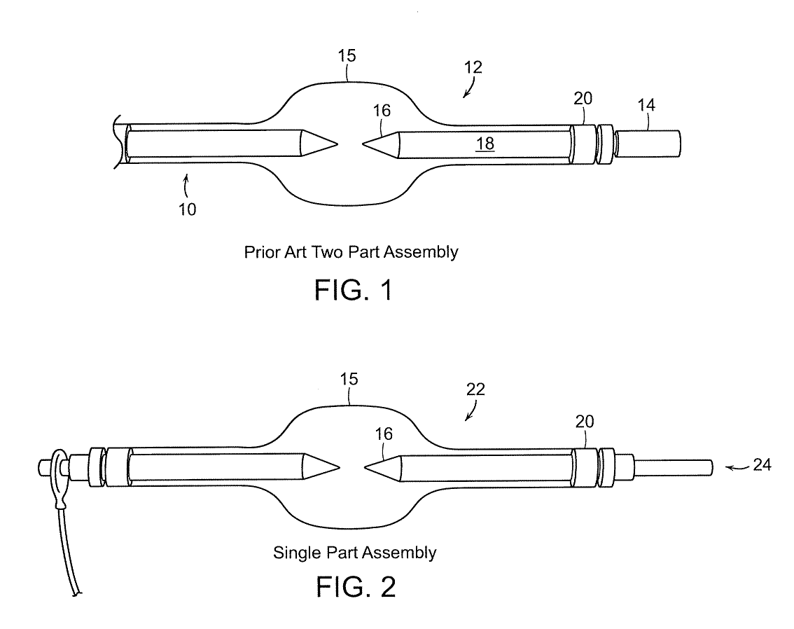

In the prior art two part assembly of FIG. 1, there is no mechanical datum point outside of the lamp's envelope that accurately defines the position of the arc. The location of the arc can vary by small amounts along all three coordinate axes through the process of binding the electrical connector to the shaft. Because the position of the arc is not well controlled, additional mechanical adjustments are typically used to align the arc of the lamp to the reflector. Otherwise, small offsets from the focus of the ellipse can create a substantial drop-off in the focused energy.

Referring to FIG. 2, to address this positioning issue, the shaft of a second electrode assembly 22 and the electrical connector are made from a single solid piece of metal such that the electrical connector can accurately define the position of the arc relative to a holder and a reflector (if used). As indicated in FIG. 2, in a single part assembly, the electrode shaft and end connector 24 are preferably formed as a unitary and monolithic piece. The electrode portion is substantially the same as the prior art, but the connector portion has a reduced diameter portion and further has some means, such as through the use of one or more shoulders or a keying arrangement, or some other method such as use of tabs for being held within an electrically conducting holder and in a defined position along all coordinate axes relative to other components. The end of connector 24 thus provides a mechanical positioning along with electrical conductivity, and in some embodiments without a set screw or other additional mechanical attachments other than what is part of the connector 24. The length of the single-piece electrode/connector is known at manufacture, and not altered by the use of a joint between these parts. The diameters of the connector 24 can be well defined.

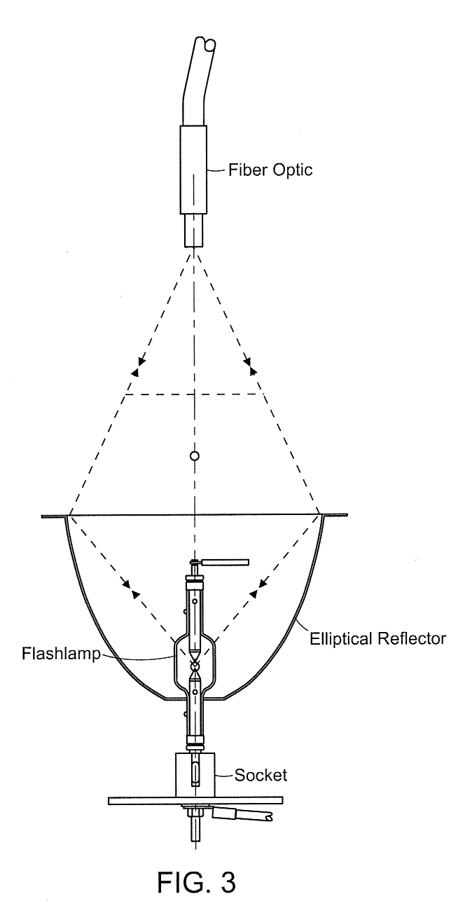

Referring to FIG. 3, the holder/socket is typically surrounded by a reflector, such as an elliptical reflector. This assembly thus allows the position of the arc to be accurately defined relative to the reflector and allows one to avoid the requirement of using a knob or screw to adjust a position or to provide a lamp or reflector in combination after careful measurement.

The single part assembly as described here can be used with an envelope that passes visible light as described above, or it can be used with a quartz envelope or other appropriate material for passing ultraviolet light.

Different applications are possible for such a point source that is used to generate a small and high intensity spot of light, including for use in providing light to an optical fiber as shown in FIG. 3. In preferred embodiments, the diameter of the spot size is less than about 0.5 inches (1.25 cm) and can be as small as the diameter of an optical fiber.

The reflector that is used can be a generally known reflector designed to reflect light to a point. This can be accomplished with an elliptical shape reflector that reflects light from one of two elliptical foci to the other of the foci. Other reflector configurations could potentially be used. In the case of an ellipse, the lamp is in a holder with a reflector around it at one end and to the side; the other focus of the ellipse is within or at the housing of the box, where a workpiece for receiving the light, such as an optical fiber, is positioned.

The electronics can be generally similar to those used in prior art pulsed lamp systems, such as a Xenon Corporation Model RC-250B system, which is designed to provide high peak, broadband, ultraviolet, and visible energy for applications, such as curing.

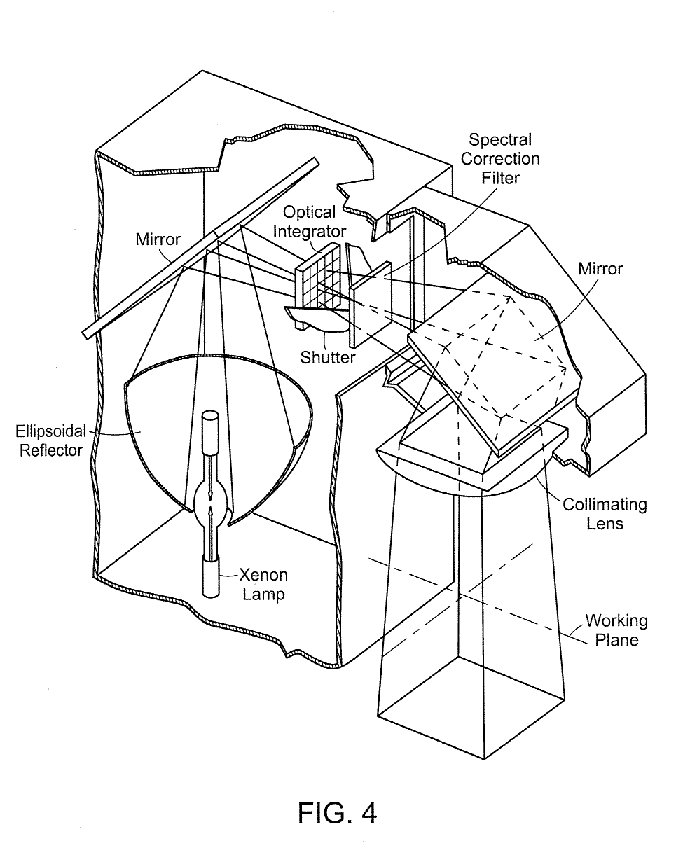

Referring to FIG. 4, the lamp can be used with a solar simulator. A solar simulator is a test device that is used to measure the efficiency of solar cells and solar panels. There are four main parameters that define how well a solar simulator replicates the properties of sunlight. These are intensity, spectrum, temporal uniformity and spatial uniformity. Because of the inherent spectral match, xenon lamps are often used for this application.

The requirement for spatial uniformity is tight. To achieve an “A” rating the uniformity over the cell that is being tested must be within 2% at 1000 watts per m2. To achieve this specification within a compact design the bulb's arc should be short, and the position of the arc well defined. The lamp assembly described in connection with FIG. 2 helps to provide the accurate definition of the arc's position.

Having described certain embodiments, it should be apparent that modifications can be made without departing from the scope of the appended claims. For example, while certain applications of the technology have been identified, such as for the use in providing light to an optical fiber, other applications could also be used.

1. An apparatus comprising:
a flash lamp assembly including:
a first electrode,
a second electrode spaced near the first electrode and held in a fixed position relative to the first electrode to define a gap across which an arc having pulsed light can be formed, and
an envelope that encloses ends of the first and second electrode and enclosed the arc there between,
wherein the second electrode has an electrode portion that extends into the envelope and an end connector portion outside the envelope, the electrode and end connector being formed as a unitary and monolithic member; a holder for holding the connector, the end connector portion of the second electrode including a mechanical connection portion for positioning the second electrode relative to the holder; and
a reflector positioned around the lamp assembly and configured to reflect light created at the gap between the electrodes to a desired location.

2. The apparatus of claim 1, wherein the reflector includes an elliptical reflector.

3. The apparatus of claim 2, wherein the elliptical shape defines two foci, wherein the lamp assembly is positioned such that the arc is formed at one of the foci and a work piece is at the other of the foci.

4. The apparatus of the claim 3, where in the workpiece includes an optical fiber.

5. The apparatus of the claim 1, wherein the envelope can pass visible light and blocks ultraviolet light.

6. The apparatus of the claim 1, wherein the envelope can pass ultraviolet light.

7. The apparatus of the claim 1, further comprising an optical fiber positioned so that the light from the lamp assembly is directed into an end of the fiber.

8. The apparatus of the claim 1, further comprising optical components for directing the light from the flash lamp to a workpiece at a working plane.

9. The apparatus of the claim 8, in combination with a solar cell serving as the workpiece.

10. The apparatus of the claim 1, wherein the mechanical connection portion includes a keyway.

11. The apparatus of the claim 1, wherein the mechanical connection portion includes a shoulder for contacting the holder.

12. The apparatus of the claim 1, wherein the electrode further includes a tip that includes tungsten, and wherein the electrode portion includes copper.

13. The apparatus of the claim 1, wherein the mechanical connection consists essentially of the mechanical connection portion formed on electrode mating with the holder.

14. An apparatus comprising:
a flash lamp assembly including:
a first electrode having a tip portion and a shaft portion,
a second electrode spaced near the first electrode and held in a fixed position relative to the first electrode to define a gap across which an arc having pulsed light can be formed, the second electrode including a tip portion and a shaft portion,
an envelope that encloses the tip portions and at least some of the shaft portions of the first and second electrodes and encloses the arc therebetween,
wherein the shaft portion of the second electrode extends outside the envelope to define an electrical connection portion that and is for extending into a holder, the electrical connection portion further including mechanical features to position the electrical connection portion within a holder, the shaft portion and the electrical connector portion being formed as a unitary and monolithic member.

15. The assembly of claim 12, further comprising a holder, wherein the holder is in direct electrical connection to the shaft through the connector portion without an intermediate bonded member.

16. The assembly of claim 12, further comprising a reflector positioned around the lamp assembly and configured and positioned to reflect light created at the gap between the electrodes to a desired location.

17. The assembly of claim 12, wherein the tip portion includes tungsten and the shaft includes copper.
